(19) United States
(12) Patent Application Publication
(10) Pub. No.: US 2025/0332805 A1
(43) Pub. Date: Oct. 30, 2025

(54) BUFFER FORMING METHOD AND BUFFER

(71) Applicant: Jui-Chun CHANG, Sugar Land, TX (US)

(72) Inventors: Jui-Chun CHANG, Sugar Land, TX (US); Wei-Wen PENG, Sugar Land, TX (US); Chih-Cheng LIU, Taichung City (TW); Fu-Wang HSIAO, Taichung City (TW)

(21) Appl. No.: 19/005,654

(22) Filed: Dec. 30, 2024

Related U.S. Application Data
(60) Provisional application No. 63/639,288, filed on Apr. 26, 2024.
(60) Provisional application No. 63/714,292, filed on Oct. 31, 2024.

(51) Int. Cl. B31D 3/02; B31D 5/02

(52) U.S. Cl. CPC B31D 3/0223; B31D 5/02

(57) ABSTRACT

A buffer forming method comprises following steps of: providing a honeycomb core, and providing a roller unit to clamp the honeycomb core for continuous pressing and conveying in a stretching direction, and to make the honeycomb core become a buffer through a feed stage, a shaping stage, and a rebound stage. The roller unit defines a feed region, a distance of which is greater than 70% of a height of a sheet material and the distance of which is smaller than the height of the sheet material, in order to make an average bending deformation degree of a plurality of intermediate segments of the honeycomb core substantially smaller than 10% in a pressing and conveying process.

### CROSS-REFERENCE TO RELATED APPLICATION

This application claims the benefit of U.S. Provisional Patent Application No. 63/639,288, which is filed on Apr. 26, 2024, and U.S. Provisional Patent Application No. 63/714,292, which is filed on Oct. 31, 2024. The aforesaid applications are incorporated by reference herein.

### TECHNICAL FIELD

The invention relates to a buffering packaging material, and more particularly to a buffer forming method and a product thereof.

### PRIOR ART

A buffering packaging material is for being stuffed between a box and items in the box to protect the items from being damaged due to impact during the shipping process. In recent years, the logistics industry has been rapidly developing, and logistics-related industries, such as manufacture of the buffering packaging materials, have also been prospering.

Currently available buffering packaging materials in general come in inflated plastic film types and honeycomb types. However, because of environmental issues, buffering packaging materials with reduced plastic are bound to be the focus for future development.

In recent years, buffering packaging materials made of paper, due to being more suitable for environmental needs in degradation and decomposition, are gradually widely-used.

U.S. Pat. No. 6,871,480 discloses a folded layer disposed between two flat sheet materials that can be continuously unfurled. A top portion and a bottom portion of the folded layer each have a plurality of end edges that are adhered to the flat sheet materials.

U.S. Pat. No. 9,649,823 discloses a packaging material that includes a core portion and at least one liner. The core portion has a plurality of walls, the walls being in three-dimensional geometric patterned structures. The three-dimensional geometric patterned structures define air spaces and reinforce structural strength of the packaging material.

It can be noted from the disclosures of the abovementioned prior art that, even though expandable packaging materials are gradually widely-used in packaging, forms of the packaging materials still do not deviate from corrugated paper forms, and are all formed by bonding flat sheet materials to folded parts.

Essentially, after formed, a solid part of the currently available packaging material only takes up 5-20% of the total volume, and the remaining volume is expansion space. Therefore, the currently available packaging material causes significant hurdles and high cost in shipping. In comparison to plastic materials, packaging materials made of paper have already caused increased cost; if high shipping cost is further added, it would be disadvantageous to the development of packaging materials made of paper.

Currently available basic elements for manufacturing a finished buffer lie in: (1) folding an expansion portion to form a folded part, and (2) bonding at least one flat sheet material to the folded part to position the folded part. Since the packaging materials disclosed in U.S. Pat. Nos. 6,871,480 and 9,649,823can be transported only after the folded part is positioned, shipping cost problems are caused.

Chinese Invention Patent Application Publication No. 115593796A discloses a shockproof honeycomb paper pad structure and a manufacturing approach thereof. The manufacturing approach is: first expanding compressed shockproof latticed paper pads into hexagonal paper strips, spacing the hexagonal paper strips evenly apart and adhering the same together to form shockproof honeycomb paper pads, and in a state where tensile strain remains constant, making the shockproof honeycomb paper pads enter an inverted scraper. Both top and bottom ends of the stretched hexagonal paper strips are deformed and bent towards a side. After the deformed shockproof latticed paper pads are transferred to a pair of rollers that has a designed gap to conduct shape rolling, a shockproof honeycomb paper pad that has a designed thickness is formed. At this time, both the top and bottom ends of the hexagonal paper strips form folded folds at non-adhered areas, and dispose a middle fold at adhered areas.

Some problems still exist in the abovementioned manufacturing approach. Since the stretched hexagonal paper strips actually have different folding resistive forces existing in the non-adhered areas and the adhered areas, when folded folds are formed at both the top and bottom ends of the non-adhered areas through the inverted scrapers, since the adhered area is formed by adhering two paper strips, stiffness is high, and the stretched hexagonal paper strips are not easy to deform directly through the inverted scrapers. Therefore, a pair of rollers that has a pre-set gap is needed, so as to conduct shape rolling.

During shape rolling, to overcome high stiffness of the adhered areas, the gap between the rollers is set to 30-50% of a height of the paper strips to conduct feeding and pressing, but this will severely undermine the shockproof effect of the honeycomb. For stable shaping, the height of the paper strips are further compressed to 50-65% of its original height. Furthermore, letting the middle of the paper strip get bent is actually equivalent to deformation from direct compression, which will overly undermine its buffering effect, and cause production speed and output stability to be severely affected.

Moreover, the adhered areas of the paper strips generate folds through significant compression, and heights are not easy to be consistent after the folds are generated, which makes the shockproof paper pad to easily generate a state of overall unevenness after being pressed and shaped.

In conclusion, in the approaches that use honeycomb cores as packaging materials, manufacturing methods that have continuous expansion shaping are important approaches, which can save high-cost shipping fees, and are advantageous to environmentally friendly reuse. However, how to simultaneously keep the middle of the paper strips from bending as much as possible to maintain a preferred buffering effect, and have a smooth and fast continuous production while the honeycomb cores are shaped and expanded is a problem that needs to be solved urgently.

### CONTENT OF INVENTION

Therefore, an object of the present invention is to provide a buffer forming method that can resolve at least one of the existing problems.

Another object of the present invention is to provide a buffer that can resolve at least one of the existing problems.

Accordingly, the buffer forming method of the present invention comprises following steps. A honeycomb core is provided, and a roller unit is provided to clamp the honeycomb core for continuous pressing and conveying in the stretching direction, and to make the honeycomb core become a buffer through a feed stage, a shaping stage, and a rebound stage. The honeycomb core includes a plurality of sheet materials elongated in a widthwise direction. The sheet materials are arranged in a stretching direction perpendicular to the widthwise direction. Each of the sheet materials has a plurality of bonded portions and a plurality of unbonded portions. The unbonded portions and the bonded portions are staggeredly arranged in the widthwise direction. In terms of each pair of the sheet materials that are adjacent, the bonded portions of one of the sheet materials are respectively joined to the bonded portions of another one of the sheet materials. Each junction of the corresponding bonded portions that are respectively joined forms a thick surrounding wall. The rolling unit has a first upper rolling friction wheel and a first lower rolling friction wheel that are arranged in a height direction perpendicular to the widthwise direction and the stretching direction. The first upper rolling friction wheel and the first lower rolling friction wheel define a feed region therebetween. At the feed stage, the first upper rolling friction wheel and the first lower rolling friction wheel clamp and convey the honeycomb core, and the honeycomb core is pressed and conveyed by a pressing-conveying force generated through outer surfaces of the first upper rolling friction wheel and the first lower rolling friction wheel rubbing against the sheet materials. Each of the thick surrounding walls has an intermediate segment extending in the height direction. A distance of the feed region in the height direction is greater than 70% of a height of the sheet material in the height direction and is smaller than the height of the sheet material in the height direction, in order to maintain an average bending deformation degree of the intermediate segments being substantially smaller than 10% in a pressing and conveying process of the honeycomb core. The rolling unit further includes a second upper rolling friction wheel and a second lower rolling friction wheel that are arranged in the height direction. The second upper rolling friction wheel and the second lower rolling friction wheel define an output region therebetween. At the shaping stage, the second upper rolling friction wheel and the second lower rolling friction wheel rub against the sheet materials and generate the pressing-conveying force to press and convey the honeycomb core. A distance of the output region in the height direction is smaller than the distance of the feed region, so that an average bending deformation degree of the intermediate segments is substantially smaller than 10% in the pressing and conveying process of the honeycomb core. A ratio of the distance of the output region to the distance of the feed region is greater than 70%. At the rebound stage, two folds are formed respectively on a top portion and a bottom portion of each of the thick surrounding walls in the height direction, the folds extending from two opposite ends of the intermediate segment. For each of the unbonded portions, the unbonded portion forms two folds respectively at a top portion and a bottom portion in the height direction. The folds maintain a structure of the buffer.

Accordingly, the buffer of the present invention is shaped and formed by expanding and extending a honeycomb core. The honeycomb core includes a plurality of sheet materials elongated in a widthwise direction. The sheet materials are arranged in a stretching direction perpendicular to the widthwise direction. Each of the sheet materials has a plurality of bonded portions and a plurality of unbonded portions. The unbonded portions and the bonded portions are staggeredly arranged in the widthwise direction. In terms of each pair of the sheet materials that are adjacent, the bonded portions of one of the sheet materials are respectively joined to the bonded portions of another one of the sheet materials, and each junction of the bonded portions forms a thick surrounding wall. Each of the thick surrounding walls and the unbonded portions of each pair of the sheet materials that are adjacent form a plurality of hexagonal honeycomb bodies. For each of the hexagonal honeycomb bodies, four of the unbonded portions form four sides with lengths that are substantially the same, and two thick surrounding walls form another two sides with lengths that are substantially same. A length of each of the bonded portions perpendicular to the height direction is not greater than 60% of a length of each of the unbonded portions perpendicular to the height direction. Each of the thick surrounding walls has an intermediate segment extending in the height direction. Two folds are formed respectively on a top portion and a bottom portion of each of the thick surrounding walls in the height direction, the folds extending from two opposite ends of the intermediate segment. For each of the unbonded portions, a top portion and a bottom portion of the unbonded portion in the height direction respectively form two folds. The top portion and the bottom portion of the unbonded portion respectively form two folds. The folds maintain the honeycomb core in an expanded state. An average bending deformation degree of the intermediate segments is substantially smaller than 10%.

### BRIEF DESCRIPTION OF THE DRAWINGS

Other features and effects of the present invention will be apparently presented in the embodying manner with reference to the drawings.

FIG. 1 is a schematic view illustrating a buffer forming method of the present invention.

FIG. 2 is a schematic perspective view illustrating a honeycomb core of an embodiment of the present invention in a state before being expanded, extended and shaped.

FIG. 3 is a fragmentary schematic perspective view illustrating the honeycomb core in a state after being expanded, extended and shaped.

FIG. 4 is a partially enlarged view of FIG. 3.

FIG. 5 is a sectional view taken along line V-V in FIG. 4.

FIG. 6 is a sectional view taken along line VI-VI in FIG. 4.

### EMBODYING MANNER

Before the invention is described in greater detail, it should be noted that in the following description, similar elements are indicated by the same reference numerals.

Related technical contents, features and effects of the present invention, in the following detailed description of the embodiments with reference to the drawings, will be clearly shown. In addition, it should be noted that, the drawings of the present invention only indicate structures and/or relative positional relationships between elements, and are not related to the actual size of each element.

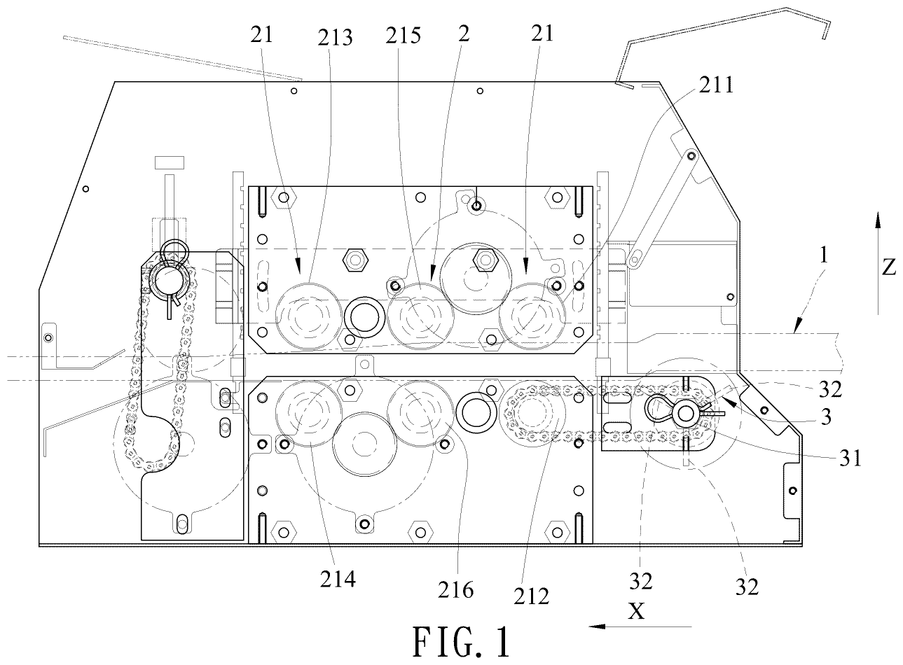

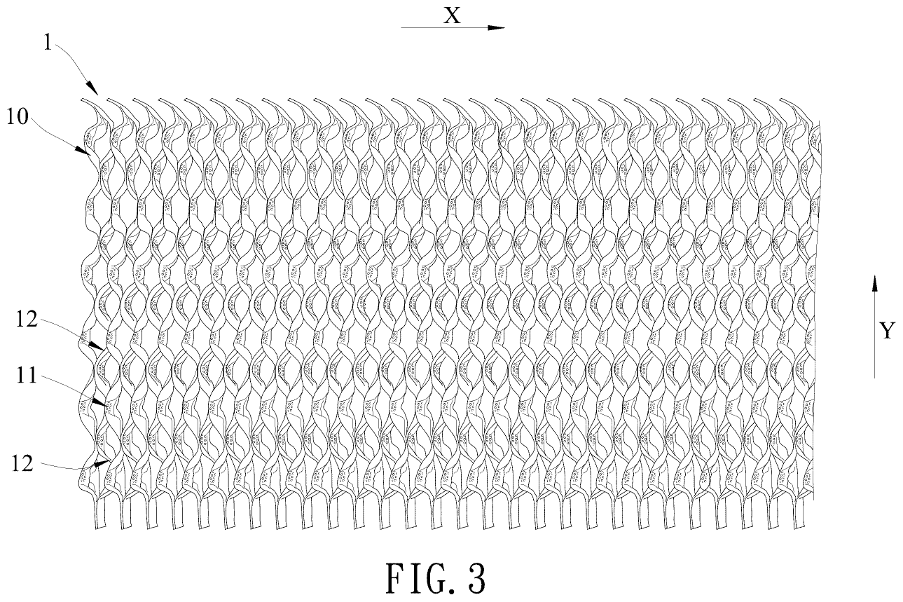

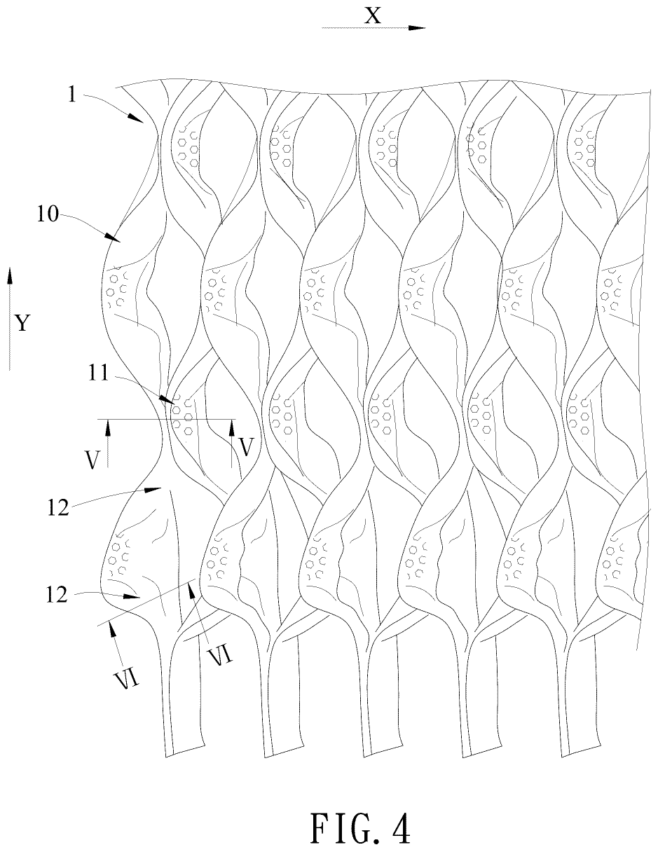

Referring to FIG. 1 to FIG. 4, a buffer forming method of the present invention is for expanding, extending, processing and shaping a honeycomb core 1. The steps of the buffer forming method are as follows. The honeycomb core 1 is clamped and continuously pressed and conveyed in a stretching direction (X) by a roller unit 2 and a material pushing unit 3, and goes through a feed stage, a shaping stage, and a rebound stage to make the honeycomb core 1 become a buffer.

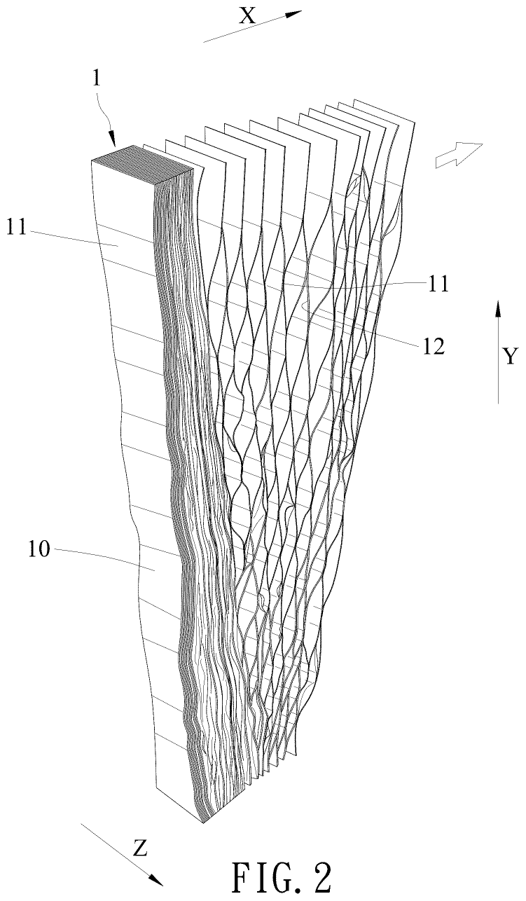

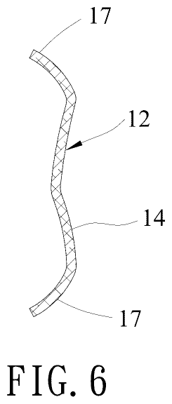

Referring to FIG. 2 and FIG. 6, the honeycomb core 1 includes a plurality of sheet materials 10 elongated in a widthwise direction (Y). The sheet materials 10 are arranged in the stretching direction (X) perpendicular to the widthwise direction (Y). Each of the sheet materials 10 has a plurality of bonded portions 11 and a plurality of unbonded portions 12. The unbonded portions 12 and the bonded portions 11 are staggeredly arranged in the widthwise direction (Y). The bonded portions 11 of two adjacent sheet materials 10 are respectively joined together, and each junction of the bonded portions 11 that are respectively joined forms a thick surrounding wall 15. Heights of the sheet materials 10 in a height direction (Z) that is perpendicular to the widthwise direction (Y) and the stretching direction (X) are substantially the same. In this embodiment, the bonded portions 11 of two adjacent sheet materials 10 are adhered to each other in the stretching direction (X) after having glue rolled thereonto. In other embodiments, the bonded portions 11 can be bonded via binding. Since the bonding method of the bonded portions 11 is matured technology of the production lines of currently available honeycomb cores 1, no further details will be provided.

Each of the sheet materials 10 of the honeycomb core 1 can be an environmentally friendly material such as a recyclable fiber material, a biodegradable material, etc. Preferably, each of the sheet materials 10 is recycled paper that has a grammage of 80 g/m²-200 g/m², and has a thickness of 0.08-0.2 mm, a length of 10-80 cm in the widthwise direction (Y), and a length of 1-6 cm in the height direction (Z). A length of each of the unbonded portions 12 in the widthwise direction (Y) is 0.5-5 cm. In this embodiment, each of the sheet materials 10 adopts recycled paper that has a grammage of 120 g/m², and has a thickness of 0.12 mm, a length of 30 cm in the widthwise direction (Y), and a length of 2 cm in the height direction (Z). A length of each of the unbonded portions 12 in the widthwise direction (Y) is 2 cm. A length of each of the bonded portions 11 in the widthwise direction (Y) is 0.9 cm.

The material pushing unit 3 has a drivable rotary wheel 31, and a plurality of levers 32 that are installed around the rotary wheel 31, and that are disposed spacedly. After a front edge of the honeycomb core 1 is pulled apart in the stretching direction (X) by two adjacent sheet materials 10 (the first sheet material 10 of the honeycomb core 1 and its adjacent sheet material 10), and is hooked onto the levers 32, the material pushing unit 3 is activated to drive the rotary wheel 31 and the levers 32 to rotate. The levers 32 are inserted between every two adjacent ones of the remaining sheet materials 10 when rotating, and push the honeycomb core 1 in the stretching direction (X) into the roller unit 2 to conduct pressing and conveying.

The roller unit 2 has at least two friction wheel sets 21. In this embodiment, the roller unit 2 includes two friction wheel sets 21. One of the friction wheel sets 21 has a first upper rolling friction wheel 211 and a first lower rolling friction wheel 212 that are arranged in the height direction (Z) for feeding. The first upper rolling friction wheel 211 and the first lower rolling friction wheel 212 define a feed region therebetween. A distance of the feed region in the height direction (Z) is 1.9 cm. At the feed stage, after the honeycomb core 1 is pushed and conveyed in the stretching direction (X) by the levers 32 into the roller unit 2, the roller unit 2 presses and conveys the honeycomb core 1 via the one of the friction wheel sets 21. When the front edge of the honeycomb core 1 is conveyed into the feed region, the first upper rolling friction wheel 211 and the first lower rolling friction wheel 212 respectively abut against a top portion and a bottom portion of each of the sheet materials 10 of the front edge of the honeycomb core 1, and the first upper rolling friction wheel 211 and the first lower rolling friction wheel 212 rotate to generate a pushing and conveying effect so that the sheet materials 10 are clamped and conveyed through the feed region. At this time, the first upper rolling friction wheel 211 and the first lower rolling friction wheel 212 press and convey the sheet materials 10 via friction and shape the top portions and the bottom portions of the sheet materials 10, forming a plurality of hexagonal honeycomb bodies that have not been completely shaped. That is to say, each of the thick surrounding walls 15 and the unbonded portions 12 of each pair of adjacent sheet materials 10 form the plurality of hexagonal honeycomb bodies. For each of the hexagonal honeycomb bodies, four of the unbonded portions 12 form four sides that are substantially the same in length and that are perpendicular to the height direction (Z), and two of the thick surrounding walls 15 form another two sides that are substantially the same in length and that are perpendicular to the height direction (Z). The length of each of the bonded portions 11 perpendicular to the height direction (Z) is not greater than 60% of the length of each of the unbonded portions 12 perpendicular to the height direction (Z). Preferably, the length of the bonded portion 11 perpendicular to the height direction (Z) is 10-45% of the length of the unbonded portion 12 perpendicular to the height direction (Z). In this embodiment, since the bonded portions 11 are bonded by glue during production of the honeycomb core 1 in a continuous production line, some tolerances exist. Furthermore, when being pulled apart, the bonded portions 11 each receive forces that are not exactly the same, so the length of each of the bonded portions 11 perpendicular to the height direction (Z) has around a 3-5% tolerance. In this embodiment, a ratio of the length of the bonded portion 11 perpendicular to the height direction (Z) to the length of the unbonded portion 12 perpendicular to the height direction (Z) is between 25 and 30%.

The embodiment guides the honeycomb core 1 into the feed region via the material pushing unit 3, but in other embodiments, a user can directly place the honeycomb core 1 into the feed region to conduct clamping and feeding via the first lower rolling friction wheel 211 and the first lower rolling friction wheel 212 as well, however, with increased danger.

Furthermore, for steady control of magnification of expansion of the honeycomb core 1, preferably, the honeycomb core 1 is caused to reach a pre-set level of expansion with a resistance-providing adjustment approach before being fed, and afterwards, the first upper rolling friction wheel 211 and the first lower rolling friction wheel 212 are caused to conduct clamping and conveying. There are plenty of approaches for the resistance-providing adjustment approach. For example, a starting position of the honeycomb core 1 is caused to be lower than the feed region to form a height discrepancy to pull the honeycomb core 1 apart via gravity before the honeycomb core 1 is fed; alternatively, a horizontal height of a placement position of the honeycomb core 1 is caused to be close to the feed region, but a roller is disposed for pressing the honeycomb core 1 at a top portion or bottom portion thereof, which increases resistance to the movement of the honeycomb core 1, and can achieve an effect of controlling the honeycomb core 1 to expand up to 20-100 times the expansion magnification by modulating resistance of the rollers before honeycomb core 1 enters the feed region.

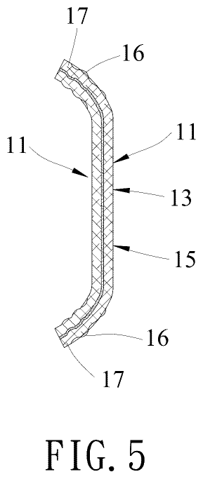

Moreover, at the feed stage, since the sheet materials 10 are clamped and conveyed by rotation of the first upper rolling friction wheel 211 and the first lower rolling friction wheel 212 in a state where the heights thereof in the height direction (Z) are greater than the distance of the feed region in the height direction (Z), and since the surfaces of the first upper rolling friction wheel 211 and the first lower rolling friction wheel 212 are coarse, friction can be produced so that the honeycomb core 1 can be pressed and conveyed. When the sheet materials 10 pass through the feed region, the first upper rolling friction wheel 211 and the first lower rolling friction wheel 212 only need rub against the top portions and bottom portions of the sheet materials 10 in order to clamp and convey the honeycomb core 1, therefore decreasing overall compression of the sheet materials 10. Referring to FIG. 5, each of the thick surrounding walls 15 has an intermediate segment 13, and the intermediate segment 13 is elongated in the height direction (Z) perpendicular to the stretching direction (X). When the sheet materials 10 pass through the feed region, an average bending deformation degree of the intermediate segments 13 is substantially smaller than 10%. Therefore, the overall deformation degree of the intermediate segments 13 can be controlled, and the impact resistance of the hexagonal honeycomb bodies is not damaged.

A discrepancy between the distance of the feed region in the height direction (Z) and the height of the sheet material 10 in the height direction (Z) is over 30%; that is to say, if the distance of the feed region in the height direction (Z) is lower than 1.4 cm, the intermediate segment 13 of each of the bonded portions 11 may be caused to bend and deform severely, which causes the buffer effect of the buffer to decrease. Therefore, the distance of the feed region in the height direction (Z) must be controlled to be greater than 70% of the height of the sheet material 10 in the height direction (Z). Moreover, since the surfaces of the friction wheels 211, 212 for clamping and conveying are coarse, friction can be produced to push the sheet materials 10, the sheet materials 10 are caused to form folds at the top portions and the bottom portions, and the structure of the intermediate segments 13 may only be slightly affected. It is preferable to control the distance of the feed region to be at 90-95% of the height of the sheet material 10 in the height direction (Z), which is between 1.8 and 1.9 cm. Each of the hexagonal honeycomb bodies is formed by binding two adjacent sheet materials 10 with glue. A thickness of each of the thick surrounding walls 15 is greater than two times a thickness of each of the unbonded portions 12. A stiffness of each of the thick surrounding walls 15 is greater than two times a stiffness of each of the unbonded portions 12. Therefore, if the length of each of the thick surrounding walls 15 perpendicular to the height direction (Z) is over 60% of the length of each of the unbonded portions 12 perpendicular to the height direction (Z), when the thick surrounding walls 15 are being folded, since the resistance of the thick surrounding walls 15 is high, deformation of each of the intermediate segments 13 is easily caused.

The other friction wheel set 21 of the rolling unit 2 further includes a second upper rolling friction wheel 213 and a second lower rolling friction wheel 214 that are arranged in the height direction (Z). The second upper rolling friction wheel 213 and the second lower rolling friction wheel 214 define an output region therebetween. A distance of the output region in the height direction (Z) is 1.4 cm. At the shaping stage, the second upper rolling friction wheel 213 and the second lower rolling friction wheel 214 rotate and clamp the top portion and the bottom portion of the slightly deformed honeycomb core 1, and produce friction to make the honeycomb core 1 move in the stretching direction (X) and pass through the feed region, which makes the sheet materials 10 that have already been stretched into honeycomb shapes further shaped.

In this embodiment, the distance of the output region is reduced compared to the distance of the feed region, a ratio of the reduction is not greater than 30% (the distance of the feed region is 1.9 cm, and the distance of the output region is 1.4 cm), and the surface of each of the friction wheels for clamping and conveying is coarse 213, 214 to have the rubbing effect; therefore, when the honeycomb core 1 passes through the output region, the average bending deformation degree of the intermediate segments 13 is substantially smaller than 10%, the impact resistance of the hexagonal honeycomb bodies is not damaged, and the buffer function of the buffer is not affected. Preferably, the distance of the output region is controlled to be smaller than 60% of the height of the sheet material 10 in the height direction (Z) to decrease chances of the intermediate segments 13 being directly bent.

Furthermore, in this embodiment, there is an auxiliary pushing and conveying stage between the feed stage and the shaping stage. The roller unit 2 further has an auxiliary friction wheel set. The auxiliary friction wheel set includes an upper auxiliary rolling friction wheel 215 disposed between the first upper rolling friction wheel 211 and the second upper rolling friction wheel 213, and a lower auxiliary rolling friction wheel 216 disposed between the first lower rolling friction wheel 212 and the second lower rolling friction wheel 214. The upper auxiliary rolling friction wheel 215 and the lower auxiliary rolling friction wheel 216 are arranged in the height direction (Z), and are rotatable. The upper auxiliary rolling friction wheel 215 and the lower auxiliary rolling friction wheel 216 define an auxiliary region therebetween. The auxiliary region is between the distance of the feed region and the output distance for the buffer to be pressed, conveyed and formed in a steadier state. In this embodiment, a distance of the auxiliary region between the upper auxiliary rolling friction wheel 215 and the lower auxiliary rolling friction wheel 216 in the height direction is 1.7 cm. That is to say, at the feed stage, the honeycomb core 1 is pressed and conveyed with the distance of the feed region being smaller than the height of the sheet material 10 in the height direction (Z) and being greater than 70% of the height of the sheet material 10 in the height direction (Z), and then at the auxiliary pressing and conveying stage, the honeycomb core 1 enters the auxiliary region, and is once again pressed and conveyed with the distance of the auxiliary region being smaller than the distance of the feed region in the height direction (Z), and finally at the shaping stage, the honeycomb core 1 is pressed and conveyed to be shaped with the distance of the output region being smaller than the distance of the auxiliary region in the height direction (Z) and being greater than 60% of the height of the sheet material 10 in the height direction (Z). The distance of the feed region is 90%-95% of the height of the sheet material 10 in the height direction (Z), the distance of the auxiliary pressing-conveying region is 80%-85% of the height of the sheet material 10, and the distance of the output region is 70%-75% of the height of the sheet material 10. In this embodiment, the height of the sheet material 10 in the height direction (Z) is 2.0 cm. The distance of the feed region is smaller than 2.0 cm, but greater than 1.4 cm, and is preferably between 1.8 cm and 1.95 cm. In this embodiment, the distance of the feed region is 1.9 cm. The distance of the auxiliary region is preferably between 1.6 cm and 1.9 cm, but smaller than the feed distance. In this embodiment, the distance of the auxiliary region is 1.7 cm. The distance of the output region is greater than 1.2 cm, but smaller than the distance of the auxiliary region and the distance of the feed region. In this embodiment, the distance of the output region is 1.4 cm. Overall, the distance of the feed region, the distance of the auxiliary region, and the distance of the output region show gradual reduction, but the reduction ratio of adjacent distances is not higher than 30%. Preferably, the distance of the feed region is 90%-95% of the height of the sheet material 10 in the height direction (Z), the distance of the auxiliary region is 80%-85% of the height of the sheet material 10 in the height direction (Z), and the distance of the output region is 70%-75% of the height of the sheet material 10 in the height direction (Z).

Referring to FIG. 6, at the rebound stage, since the sheet materials 10 have a rebounding characteristic, after the honeycomb core 1 passes through the feed region, the auxiliary region, and the output region, the sheet materials 10 rebound and are shaped, and the top portions and the bottom portions thereof produce stiffness that maintains the structure of the honeycomb core 1. At this time, an overall average height of the honeycomb core 1 returns to 1.7 cm-1.8 cm, which is around 80%-90% of its original height. In terms of each of the hexagonal honeycomb bodies, the four unbonded portions 12 and the two thick surrounding walls 15 have folded states; that is to say, for each of the thick surrounding walls 15, two folds 17 are formed respectively on a top portion and a bottom portion of the thick surrounding wall 15, and extend from two opposite ends of the intermediate segment 13, and for each of the unbonded portions 12, two folds 17 are formed respectively on a top portion and a bottom portion of the unbonded portion 12; the differences in stiffness between the folds 17 of each of the thick surrounding walls 15 and the folds 17 of each of the unbonded portions 12 will not cause an overly large discrepancy between the lengths thereof. Compared to each of the intermediate segments 13 of a honeycomb core 1 that has not been through the feed stage, the shaping stage, and the rebound stage, the average deformation degree of the intermediate segments 13 of each of the bonded portions 11 is smaller than 10%. For each of the thick surrounding walls 15 or the unbonded portions 12, an average length of the folds 17 is between around 0.1 and 0.3 cm, and an average of a sum of the lengths of the folds 17 of the top portion and the bottom portion is between 10%-30% of the length of the sheet material 10 in the height direction (Z). Each of the folds 17 is bent at a fold angle relative to the intermediate segment 13. Angles of the fold angles may have differences as they are affected by the rubbing in the pressing and conveying process as well as the final partial shaping rebound, but they at least will not be completely parallel to the intermediate segments 13. Most of the sheet materials 10 resiliently rebound after the pressing and conveying is finished, and the overall top surface or bottom surface of the honeycomb core 1 is maintained to be substantially level.

Accordingly, the present invention provides a buffer. The buffer is shaped and formed from expanding the honeycomb core 1, and includes includes a plurality of sheet materials 10 elongated in the widthwise direction (Y). Each of the sheet materials 10 has a plurality of bonded portions 11 and a plurality of unbonded portions 12. The unbonded portions 12 and the bonded portions 11 are staggeredly arranged along the widthwise direction (Y). The bonded portions 11 of two adjacent sheet materials 10 are respectively joined together, and each junction of the bonded portions 11 forms the thick surrounding wall 15. Each of the thick surrounding walls 15 and the unbonded portions 12 of each pair of adjacent sheet materials 10 form a plurality of hexagonal honeycomb bodies. For each of the hexagonal honeycomb bodies, four of the unbonded portions 12 form four sides that are substantially same in length and that are perpendicular to the height direction (Z), and two of the thick surrounding walls 15 form another two sides that are substantially same in length and that are perpendicular to the height direction (Z). The length of each of the bonded portions 11 perpendicular to the height direction (Z) is not greater than 60% of the length of each of the unbonded portions 12 perpendicular to the height direction (Z). Preferably, the length of each of the bonded portions 11 perpendicular to the height direction (Z) is 10-45% of the length of the unbonded portion 12 perpendicular to the height direction. After the honeycomb core 1 is expanded, the folds 17 of each of the thick surrounding walls 15 and the folds 17 of each of the unbonded portions 12 are continuous, and an average of a sum of the lengths of the folds 17 is between 10% and 30% of the length of the sheet material in the height direction (Z). The average bending deformation degree of the intermediate segments 13 is substantially smaller than 10%. The folds 17 are used for maintaining the honeycomb core 1 in the expanded state for forming the buffer. Furthermore, for each of the unbonded portions 12, the unbonded portion 12 further has a thin surrounding wall 14 located between the folds 17. For each of the thick surrounding walls 15, the thick surrounding wall 15 has an embossed portion 16 formed on the folds 17. The embossed portion 16 is formed by pressing when the roller units 2 form the folds 17 of the thick surrounding wall 15, which allows the honeycomb core 1 to be more steadily shaped after rebounding.

However, the above description is merely an embodiment of the present invention, and certainly the scope of the present invention in practice cannot be limited thereby. Any simple equivalent variation and modification made according to the claims of the present invention and the contents of patent specification should fall within the scope covered by a patent to the present invention.

1. A buffer forming method comprising following steps of:
providing a honeycomb core, the honeycomb core including a plurality of sheet materials elongated in a widthwise direction, the sheet materials being arranged in a stretching direction perpendicular to the widthwise direction, each of the sheet materials having a plurality of bonded portions and a plurality of unbonded portions, the unbonded portions and the bonded portions being staggeredly arranged in the widthwise direction, wherein in terms of each pair of the sheet materials that are adjacent, the bonded portions of one of the sheet materials are respectively joined to the bonded portions of another one of the sheet materials, and each junction of the bonded portions that are respectively joined forms a thick surrounding wall; and
providing a roller unit to clamp the honeycomb core for continuous pressing and conveying in the stretching direction, and to make the honeycomb core become a buffer through a feed stage, a shaping stage and a rebound stage;
wherein, the rolling unit has a first upper rolling friction wheel and a first lower rolling friction wheel that are arranged in a height direction perpendicular to the widthwise direction and the stretching direction, the first upper rolling friction wheel and the first lower rolling friction wheel defining a feed region therebetween;
wherein, at the feed stage, the first upper rolling friction wheel and the first lower rolling friction wheel clamp and convey the honeycomb core, and through outer surfaces of the first upper rolling friction wheel and the first lower rolling friction wheel rubbing the sheet materials, a pressing-conveying force is generated to press and convey the honeycomb core;
wherein, each of the thick surrounding walls has an intermediate segment extending in the height direction, a distance of the feed region in the height direction being greater than 70% of a height of the sheet material in the height direction and being smaller than the height of the sheet materials in the height direction, in order to maintain an average bending deformation degree of the intermediate segments being substantially smaller than 10% in a pressing and conveying process of the honeycomb core;
wherein, the rolling unit further includes a second upper rolling friction wheel and a second lower rolling friction wheel that are arranged in the height direction, the second upper rolling friction wheel and the second lower rolling friction wheel defining an output region therebetween;
wherein, at the shaping stage, the second upper rolling friction wheel and the second lower rolling friction wheel rub against the sheet materials and generate a pressing-conveying force to press and convey the honeycomb core, a distance of the output region in the height direction being smaller than the distance of the feed region, so that an average bending deformation degree of the intermediate segments is substantially smaller than 10% in a pressing and conveying process of the honeycomb core, a ratio of the distance of the output region to the distance of the feed region being greater than 70%; and
wherein, at the rebound stage, two folds are formed respectively on a top portion and a bottom portion of each of the thick surrounding walls in the height direction, the folds extending from two opposite ends of the intermediate segment;
and for each of the unbonded portions, a top portion and a bottom portion of the unbonded portion in the height direction respectively form two folds, the folds maintaining a structure of the buffer.

2. The buffer forming method as claimed in claim 1, wherein the sheet materials are made of a fiber material that has a grammage of 80 g/m²-200 g/m², have a thickness of 0.08-0.2 mm, a length of 10-80 cm in the widthwise direction, and a length of 1-6 cm in the height direction, a length of each of the unbonded portions in the widthwise direction being 0.5-5 cm.

3. The buffer forming method as claimed in claim 1, wherein: at the feed stage, the honeycomb core is expanded to make each of the thick surrounding walls and the unbonded portions of each pair of the sheet materials that are adjacent form a plurality of hexagonal honeycomb bodies; for each of the hexagonal honeycomb bodies, four of the unbonded portions form four sides that are substantially same in length and that are perpendicular to the height direction, and two of the thick surrounding walls form another two sides that are substantially same in length and that are perpendicular to the height direction, a length of each of the bonded portions perpendicular to the height direction being 10-45% of the length of each of the unbonded portions perpendicular to the height direction.

4. The sheet material buffer forming method as claimed in claim 1, wherein:
before the shaping stage, the feed stage is followed by an auxiliary pushing and conveying stage, the roller unit further including an upper auxiliary rolling friction wheel disposed between the first upper rolling friction wheel and the second upper rolling friction wheel, and a lower auxiliary rolling friction wheel disposed between the first lower rolling friction wheel and the second lower rolling friction wheel, the upper auxiliary rolling friction wheel and the lower auxiliary rolling friction wheel being arranged in the height direction, the upper auxiliary rolling friction wheel and the lower auxiliary rolling friction wheel defining an auxiliary region therebetween;
at the auxiliary pushing and conveying stage, the upper auxiliary rolling friction wheel and the lower auxiliary rolling friction wheel rub against the sheet materials and generate a pressing-conveying force to press and convey the honeycomb core; and
the distance of the feed region is 90-95% of the height of the sheet material in the height direction, a distance of the auxiliary pressing-conveying region in the height direction being 80%-85% of the height of the sheet material in the height direction, the distance of the output region being 70%-75% of the height of the sheet material in the height direction.

5. A buffer shaped and formed by expanding and extending a honeycomb core, the honeycomb core including a plurality of sheet materials elongated in a widthwise direction, the sheet materials being arranged in a stretching direction perpendicular to the widthwise direction, each of the sheet materials having a plurality of bonded portions and a plurality of unbonded portions, the unbonded portions and the bonded portions being staggeredly arranged along the widthwise direction, wherein in terms of each pair of sheet materials that are adjacent, the bonded portions of one of the sheet materials are respectively joined to the bonded portions of another one of the sheet materials, each junction of the bonded portions forming a thick surrounding wall, each of the thick surrounding walls and the unbonded portions of each pair of the sheet materials that are adjacent forming a plurality of hexagonal honeycomb bodies, wherein for each of the hexagonal honeycomb bodies, four of the unbonded portions form four sides with lengths that are substantially same, and two thick surrounding walls form another two sides with lengths that are substantially same, a length of each of the bonded portions perpendicular to the height direction being not greater than 60% of a length of each of the unbonded portions perpendicular to the height direction, each of the thick surrounding walls having an intermediate segment extending in the height direction, two folds are formed respectively on a top portion and a bottom portion of each of the thick surrounding walls in the height direction, the folds extending from two opposite ends of the intermediate segment, and wherein for each of the unbonded portions, the unbonded portion forms two folds respectively at a top portion and a bottom portion in the height direction, and the folds are formed respectively at the top portion and the bottom portion of the unbonded portion, the folds maintaining the honeycomb core in an expanded state, an average bending deformation degree of the intermediate segments being substantially smaller than 10%.

6. The buffer as claimed in claim 5, wherein, the sheet materials are made of a fiber material that has a grammage of 80 g/m²˜200 g/m², have a thickness of 0.08-0.2 mm, a length of 10-80 cm in the widthwise direction, and a length of 1-6 cm in the height direction, the length of each of the unbonded portions in the widthwise direction being 0.5-5 cm, a length of each of the bonded portions perpendicular to the height direction being 10-45% of the length of each of the unbonded portions perpendicular to the height direction.

7. The buffer as claimed in claim 5, wherein each of the unbonded portions has a thin surrounding wall, each of the thick surrounding walls having two patterned portions that are respectively formed on the folds thereof.

8. A buffer forming method comprising following steps of:
providing a honeycomb core, the honeycomb core including a plurality of sheet materials, each of the sheet materials having a plurality of bonded portions and a plurality of unbonded portions, the unbonded portions and the bonded portions being staggeredly arranged, wherein in terms of each pair of sheet materials that are adjacent, the bonded portions of one of the sheet materials are respectively joined to the bonded portions of another one of the sheet materials, heights of the sheet materials in a height direction being substantially same, heights of the sheet materials in the height direction being between 1 cm and 6 cm and thicknesses thereof being between 0.08 mm and 0.2 mm; and
providing a roller unit to clamp the honeycomb core for continuous pressing and conveying in a stretching direction through at least two friction wheel sets, and making the honeycomb core become a buffer through a feed stage, a shaping stage, and a rebound stage;
wherein, respective surfaces of the at least two friction wheel sets are coarse, the friction wheel sets pressing and conveying the honeycomb core through friction; and
wherein, the at least two friction wheel sets define a feed region and an output region, a distance of the feed region in the height direction and a distance of the output region in the height direction both being smaller than the height of the sheet materials in the height distance, the distance of the feed region in the height direction being greater than 70% of the height of the sheet material in the height direction, the distance of the output region in the height direction being smaller than the distance of the feed region in the height direction.

9. The buffer forming method as claimed in claim 8, wherein:
the sheet materials are made of a fiber material that has a grammage of 80 g/m²˜200 g/m², have a thickness of 0.08˜0.2 mm, and a length of 10˜80 cm in the widthwise direction;
each of the sheet materials further has a plurality of unbonded portions that are staggeredly arranged with the bonded portions;
each of the thick surrounding walls and the unbonded portions of each pair of the sheet materials that are adjacent form a plurality of hexagonal honeycomb bodies; and
for each of the hexagonal honeycomb bodies, four of the unbonded portions form four sides that are substantially same in length and that are perpendicular to the height direction, and two of the thick surrounding walls form another two sides that are substantially same in length and that are perpendicular to the height direction, the length of each of the bonded portions perpendicular to the height direction being 10-45% of the length of each of the unbonded portions perpendicular to the height direction.

10. The buffer forming method as claimed in claim 8, wherein:
the roller unit further includes an auxiliary friction wheel set disposed between the at least two friction wheel sets, the auxiliary friction wheel set defining an auxiliary region; and
a distance of the auxiliary region in the height direction is smaller than the distance of the feed region and is greater than the distance of the output region.
